(19) United States
(12) Patent Application Publication
(10) Pub. No.: US 2005/0023849 A1
(43) Pub. Date: Feb. 3, 2005

(54) Extendable apparatus for hanging items

(76) Inventor: Joseph F. Ganter, Pittsburgh, PA (US)

Correspondence Address: JAMES RAY & ASSOCIATES, 2640 PITCAIRN ROAD, MONROEVILLE, PA, 15146, US

(21) Appl. No.: 10/629,275

(22) Filed: Jul. 29, 2003

(51) Int. Cl. B25J 1/00

(52) U.S. Cl. 294/19.1

(57) ABSTRACT

An apparatus for at least one of installing and removing a pre-selected item in difficult to reach places such apparatus comprises a rod having a predetermined length, and predetermined size, a positioning means having a predetermined end configuration, a predetermined size, and predetermined shape engageable with such rod for positioning such pre-selected item. It also includes a connecting means engageable with each of the positioning means and the rod for connecting the positioning means to the rod.

### FIELD OF INVENTION

The present invention relates, in general, to extension devices and handles, and more particularly to an extendable pole for installing and removing lights, ornaments, decorations, or other pre-selected items in difficult to reach places.

### BACKGROUND OF THE INVENTION

Prior to the present invention, as is generally well known, too often it is necessary to access high or hard to reach locations while installing or removing lights, ornaments, decorations, or other various accessories in either household or commercial environments. People often use stepladders, chairs, or other convenient articles to stand on for access to higher, more difficult to reach areas. However, many of these devices are not particularly safe for such use, and while many ladders have been constructed specifically for that purpose and which are relatively safe for use, it is necessary to step down, reposition the ladder or other support, and again climb up the ladder or support, every few feet during an installation or removal process; such as, hanging lights in a tree.

### SUMMARY OF THE INVENTION

The present invention provides an apparatus for at least one of installing and removing a pre-selected item in difficult to reach places. Such apparatus comprises a rod having a predetermined length and predetermined size. A positioning means having a predetermined end configuration, a predetermined size, and predetermined shape is engageable with such rod for positioning such pre-selected item. It also includes a connecting means engageable with each of the positioning means and the rod for connecting the positioning means to the rod.

The present invention further provides an apparatus for at least one of installing and removing ornamental light clips on at least one of a gutter and a roof of a house. The apparatus includes an extendable rod having a variable length, and predetermined size. There is an affixing means provided which has a predetermined end configuration, a predetermined size, and predetermined shape. The affixing means is engageable with the extendable rod and the ornamental light clips for at least one of installing and removing the ornamental light clips. Finally the apparatus includes a connecting means engageable with each of the affixing means and the extendable rod for connecting the affixing means to the extendable rod.

### OBJECTS OF THE INVENTION

It is, therefore, one of the primary objects of the present invention to provide an apparatus for at least one of installing and removing a pre-selected item in difficult to reach places in a cost effective manner.

It is also an object of the present invention to provide an apparatus for at least one of installing and removing a pre-selected item in difficult to reach places which is lightweight.

Another object of the present invention is to provide an apparatus for at least one of installing and removing a pre-selected item in difficult to reach places which is relatively safe to use.

Another object of the present invention is to provide an apparatus for at least one of installing and removing a pre-selected item in difficult to reach places which is easily stored in the home or office.

Another object of the present invention is to provide an apparatus for at least one of installing and removing a pre-selected item in difficult to reach places which is extendable in various increments.

These and various other objects and advantages of this invention will become more readily apparent to those persons skilled in the art after a full reading of the following detailed description, particularly, when such description is read in conjunction with the attached drawings as described below and the appended claims.

### BRIEF DESCRIPTION OF THE DRAWINGS

FIG. 1 is an assembly view of an apparatus for at least one of installing and removing a pre-selected item in difficult to reach places.

FIG. 2 is an assembly view of an apparatus for at least one of installing and removing ornamental light clips in difficult to reach places.

### BRIEF DESCRIPTION OF THE PRESENTLY PREFERRED AND ALTERNATE EMBODIMENTS OF THE INVENTION

Prior to proceeding with the more detailed description of the present invention it should be noted that, for the sake of clarity, identical components, which have identical functions have been designated by identical reference numerals throughout the drawing Figures.

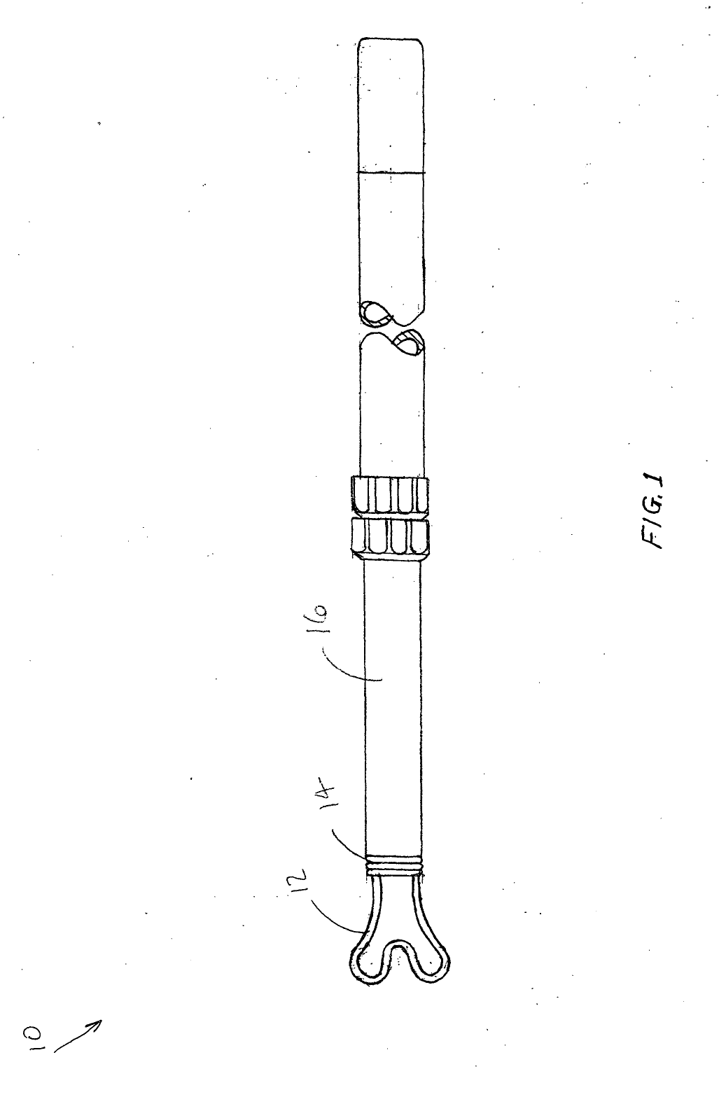

Reference is now made to FIG. 1. FIG. 1 shows an assembly view of an apparatus for at least one of installing and removing a pre-selected item in difficult to reach places, generally designated 10. The apparatus 10 comprises a rod 16 having a predetermined length, and predetermined size. It also includes a positioning means 12 having a predetermined end configuration, a predetermined size, and predetermined shape engageable with the rod 16 for positioning such pre-selected item. The predetermined shape is at least one of a U-shape, V-shape, and J-shape. Preferably the predetermined shape is a U-Shape.

The positioning means 12 is made from a predetermined material. In the presently preferred embodiment of the invention such predetermined material is non-conductive. Non-conductive materials are normally non-metallic materials, such as fiberglass and plastic. The positioning means 12 is preferably made from a plastic that is selected from a group consisting of Kynal, nylon, Kevlar, polyester, and phenolic resin. Most cost effective would be to have the positioning means 12 made from nylon.

Furthermore apparatus 10 includes a connecting means 14 engageable with each of the positioning means 12 and the rod 16 for connecting the positioning means 12 to the rod 16.

Preferably, the connecting means 14 is at least one of a universal standard, slip-on, quick release, or magnetic. In the presently preferred embodiment, the connecting means 14 is a universal standard. The universal standard for a connecting means 14 is an Acme thread. Such Acme thread is a conventional V-shaped thread to withstand forces exerted on the positioning means 12 connected to the rod 16.

The rod 16 is an extendable rod, which is extendable in at least one of fixed increments and infinite increments. Typically the rod 16 is extendable in infinite increments.

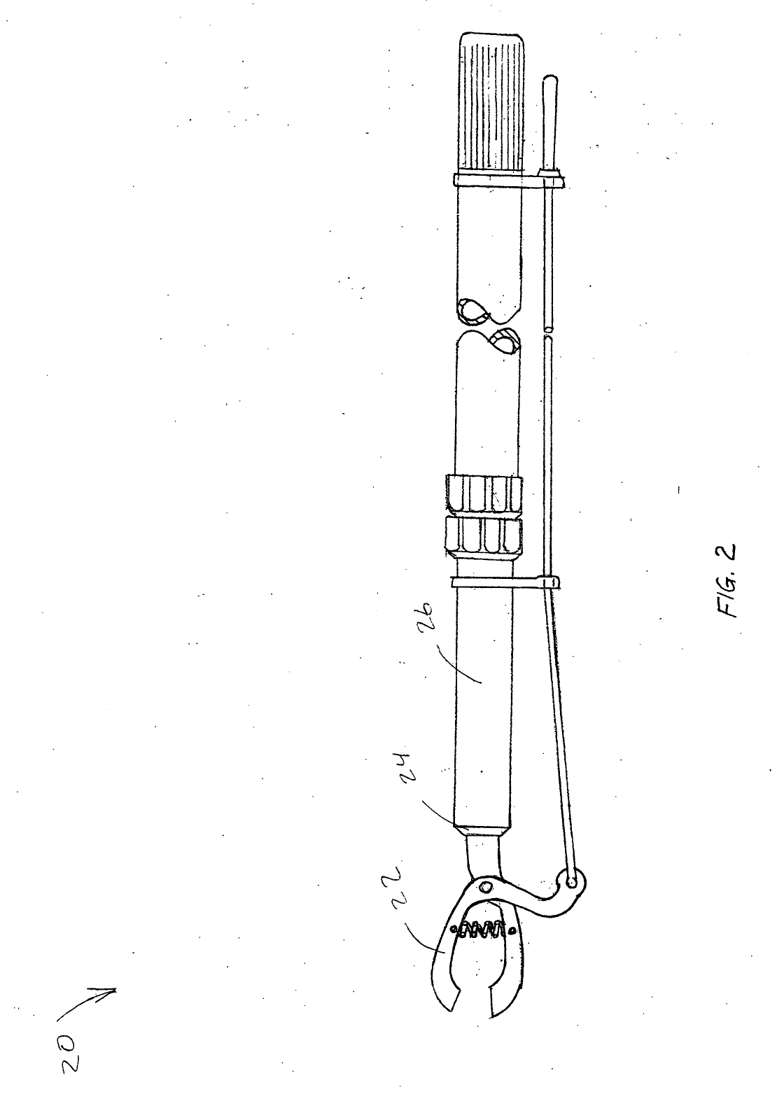

Reference is now made to FIG. 2. FIG. 2 shows an assembly view of an apparatus, generally designated 20, for at least one of installing and removing ornamental light clips on at least one of a gutter and a roof of a house. The apparatus 20 comprises an extendable rod 26 having a variable length, and predetermined size. It also includes an affixing means 22 which has a predetermined end configuration, a predetermined size, and predetermined shape engageable with the extendable rod 26 and such ornamental light clips for at least one of installing and removing such ornamental light clips. Furthermore, it includes a connecting means 24 engageable with each the affixing means 22 and the extendable rod 26 for connecting the affixing means 22 to the extendable rod 26.

The predetermined shape of the affixing means 22 is at least one of a slip-joint and scissor-style clamp. Preferably the predetermined shape is a scissor-style clamp.

While both the presently preferred and a number of alternative embodiments of the present invention have been described in detail above it should be understood that various other adaptations and modifications of the present invention can be envisioned by those persons who are skilled in the relevant art without departing from either the spirit of the invention or the scope of the appended claims.

1. An apparatus for at least one of installing and removing a pre-selected item in difficult to reach places, said apparatus comprising:
a) a rod having a predetermined length, and predetermined size;
b) a positioning means having a predetermined end configuration, a predetermined size, and predetermined shape engageable with said rod for positioning such pre-selected item; and
c) a connecting means engageable with each of said positioning means and said rod for connecting said positioning means to said rod.

2. An apparatus, according to claim 1, wherein said connecting means is at least one of a universal standard, slip-on, quick release, and magnetic.

3. An apparatus, according to claim 2, wherein said connecting means is a universal standard.

4. An apparatus, according to claim 3, wherein said universal standard is an Acme thread.

5. An apparatus, according to claim 4, wherein said Acme thread is a conventional V-shaped thread to withstand forces exerted on said positioning means connected to said rod.

6. An apparatus, according to claim 1, wherein said predetermined shape is at least one of a U-shape, V-shape, and J-shape.

7. An apparatus, according to claim 6, wherein said predetermined shape is said U-shape.

8. An apparatus, according to claim 1, wherein said rod is an extendable rod.

9. An apparatus, according to claim 8, wherein said extendable rod is extendable in at least one of fixed increments and infinite increments.

10. An apparatus, according to claim 9, wherein said extendable rod is extendable in infinite increments.

11. An apparatus, according to claim 1, wherein said positioning means is a predetermined material.

12. An apparatus, according to claim 11, wherein said predetermined material is a non-conductive material.

13. An apparatus, according to claim 12, wherein said non-conductive material is a non-metallic material.

14. An apparatus, according to claim 13, wherein said non-metallic material is made from at least one of a fiberglass material and plastic material.

15. An apparatus, according to claim 14, wherein said non-metallic material is said plastic material.

16. An apparatus, according to claim 15, wherein said plastic material is selected from a group consisting of Kynal, nylon, Kevlar, polyester, and phenolic resin.

17. An apparatus, according to claim 16, wherein said plastic material is nylon.

18. An apparatus for at least one of installing and removing ornamental light clips on at least one of a gutter and a roof of a house, said apparatus comprising:
a) an extendable rod having a variable length, and predetermined size;
b) an affixing means having a predetermined end configuration, a predetermined size, and predetermined shape engageable with said extendable rod and such ornamental light clips for at least one of installing and removing such ornamental light clips; and
c) a connecting means engageable with each of said affixing means and said extendable rod for connecting said affixing means to said extendable rod.

19. An apparatus, according to claim 18, wherein said predetermined shape is at least one of a slip-joint and scissor-style clamp.

20. An apparatus, according to claim 19, wherein said predetermined shape is a scissor-style clamp.
